(19) United States
(12) Patent Application Publication
(10) Pub. No.: US 2013/0282393 A1
(43) Pub. Date: Oct. 24, 2013

(54) COMBINING KNOWLEDGE AND DATA DRIVEN INSIGHTS FOR IDENTIFYING RISK FACTORS IN HEALTHCARE

(71) Applicants: Shahram Ebadollahi, White Plains, NY (US); Jianying Hu, Bronx, NY (US); Dijun Luo, Arlington, TX (US); Marianthi Markatou, New York, NY (US); Jimeng Sun, White Plains, NY (US); Fei Wang, Ossining, NY (US)

(72) Inventors: Shahram Ebadollahi, White Plains, NY (US); Jianying Hu, Bronx, NY (US); Dijun Luo, Arlington, TX (US); Marianthi Markatou, New York, NY (US); Jimeng Sun, White Plains, NY (US); Fei Wang, Ossining, NY (US)

(73) Assignee: INTERNATIONAL BUSINESS MACHINES CORPORATION, ARMONK, NY (US)

(21) Appl. No.: 13/611,366

(22) Filed: Sep. 12, 2012

Related U.S. Application Data
(63) Continuation of application No. 13/451,982, filed on Apr. 20, 2012.

(51) Int. Cl. G06Q 50/22

(52) U.S. Cl. 705/2

(57) ABSTRACT

Systems and methods for risk factor identification include identifying a first set of risk factors from personal data. A second set of risk factors is identified from at least one of a user input and a knowledge source. The first set is combined with the second set, using a processor, by selecting a number of risk factors from the first set that augment the second set of risk factors to determine a combined list of risk factors that predict a condition of interest.

### RELATED APPLICATION DATA

This application is a Continuation application of co-pending U.S. patent application Ser. No. 13/451,982 filed on Apr. 20, 2012, incorporated herein by reference in its entirety.

### BACKGROUND

1. Technical Field

The present invention relates to risk factor identification, and more particularly to systems and methods for combining knowledge and data driven insights for identifying risk factors in healthcare.

2. Description of the Related Art

As more clinical information with increasing diversity becomes available for analysis, a large number of features can be constructed and leveraged for predictive modeling. The ability to identify risk factors related to an adverse health condition (e.g., congestive heart failure) is very important for improving healthcare quality and reducing cost. The identification of risk factors may allow for the early detection of the onset of diseases so that aggressive intervention may be taken to slow or prevent costly and potentially life threatening conditions. The identification of salient risk factors allows for the design of the most appropriate intervention to target specific risk factors.

### SUMMARY

A computer implemented method for risk factor identification includes identifying a first set of risk factors from personal data. A second set of risk factors is identified from at least one of a user input and a knowledge source. The first set is combined with the second set, using a processor, by selecting a number of risk factors from the first set that augment the second set of risk factors to determine a combined list of risk factors that predict a condition of interest.

A computer implemented method for risk factor identification includes identifying a first set of risk factors from personal data. A second set of risk factors is identified from at least one of a user input and a knowledge source. The first set is combined with the second set, using a processor, by selecting a number of risk factors from the first set that augment the second set of risk factors. Combining includes modeling the first set and the second set as an objective function and minimizing the objective function with respect to a set of regression coefficients to determine a combined list of risk factors that predict a condition of interest.

A system for risk factor identification includes a data processing module configured to identify a first set of risk factors from personal data. A knowledge based processing module is configured to identify a second set of risk factors from at least one of a user input and a knowledge source. A processor is configured to implement an augmentation module, which is configured to combine the first set with the second set by selecting a number of risk factors from the first set that augment the second set of risk factors to determine a combined list of risk factors that predict a condition of interest.

A system for risk factor identification includes a data processing module configured to identify a first set of risk factors from personal data. A knowledge based processing module is configured to identify a second set of risk factors from at least one of a user input and a knowledge source. A processor is configured to implement an augmentation module, which is configured to combine the first set with the second set by selecting a number of risk factors from the first set that augment the second set of risk factors. The augmentation module is further configured to model the first set and the second set as an objective function and minimize the objective function with respect to a set of regression coefficients to determine a combined list of risk factors that predict a condition of interest.

A computer readable storage medium comprises a computer readable program for risk factor identification. The computer readable program when executed on a computer causes the computer to identify a first set of risk factors from personal data. A second set of risk factors is identified from at least one of a user input and a knowledge source. The first set is combined with the second set, using a processor, by selecting a number of risk factors from the first set that augment the second set of risk factors to determine a combined list of risk factors that predict a condition of interest.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustratively depicting a high level system/method for risk factor identification, in accordance with one embodiment;

FIG. 2 is a block/flow diagram showing a system/method for risk factor identification, in accordance with one embodiment;

FIG. 3 is a block/flow diagram showing a system/method for a data driven approach to risk factor identification, in accordance with one embodiment; and

FIG. 4 is a block/flow diagram showing a system/method for risk factor identification by augmenting knowledge based risk factors with data driven risk factors, in accordance with one illustrative embodiment.

### DETAILED DESCRIPTION OF PREFERRED EMBODIMENTS

In accordance with the present principles, systems and methods for risk factor identification are provided. A number of data driven risk factors may be received that are identified based on personal data. In addition, a number of knowledge based risk factors may be received that are identified based on at least one of user input and knowledge sources. The number of data driven risk factors and the number of knowledge based risk factors may be modeled as an objective function. In one embodiment, the objective function includes a linear regression objective under square loss. In yet another embodiment, the objective function is represented such that risk factors are non-redundant. In still another embodiment, the number of data driven risk factors selected is as small as possible.

The objective function may be minimized using iterative methods to select data driven risk factors that augment the knowledge based risk factors. The objective function may be minimized with respect to the regression coefficient. In a preferable embodiment, a novel Scalable Orthogonal Regression (SOR) method is implemented to select data driven risk factors that are complementary to the knowledge based risk factors. Advantageously, the present principles are more reliable and interpretable than pure data driven approaches. In addition, the present principles are more comprehensive and efficient than pure knowledge based approaches.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

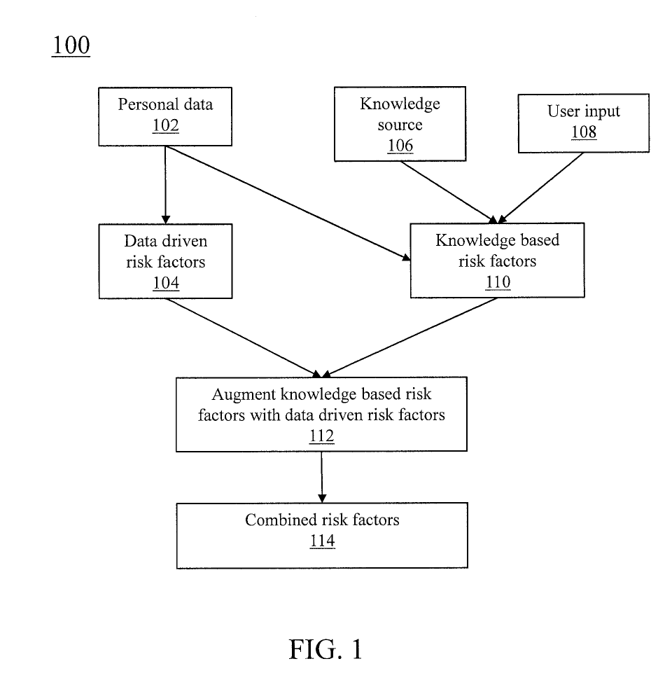

Referring now to the drawings in which like numerals represent the same or similar elements and initially to FIG. 1, a block/flow diagram showing a high level system/method for risk factor identification is illustratively depicted in accordance with one embodiment. Personal data 102 may be processed to identify data driven risk factors 104 using feature selection techniques. Personal data 102 may include, for example, electronic health records indicating diagnosis information, medication information, lab results, vital information, etc. Feature selections techniques may include computer implemented methods to identify a number of potential risk factors from, e.g., electronic health records of a large pool of patients, as manual feature selection may be impractical and may lead to inaccuracies.

Knowledge source 106 may be parsed and/or user input 108 may be received to identify knowledge based risk factors 110. Knowledge source 106 may include any veracious information source, such as, e.g., credited clinical guidelines, medical literature, publications, etc. Parsing of knowledge source 106 may include applying a computer implemented parsing method to identify references to clinical concepts and disease conditions by processing a copious amount of information sources. A computer implemented parsing method may be necessary to process such a copious amount of information sources, as manual parsing of information sources may be impractical and inaccurate. User input 108 may include expert input (e.g., physician).

In block 112, risk factors of data driven risk factors 104 are selected to augment knowledge based risk factors 110. In one embodiment, the SOR method is applied to select data driven risk factors. In block 114, a combined list of risk factors may be determined as an output.

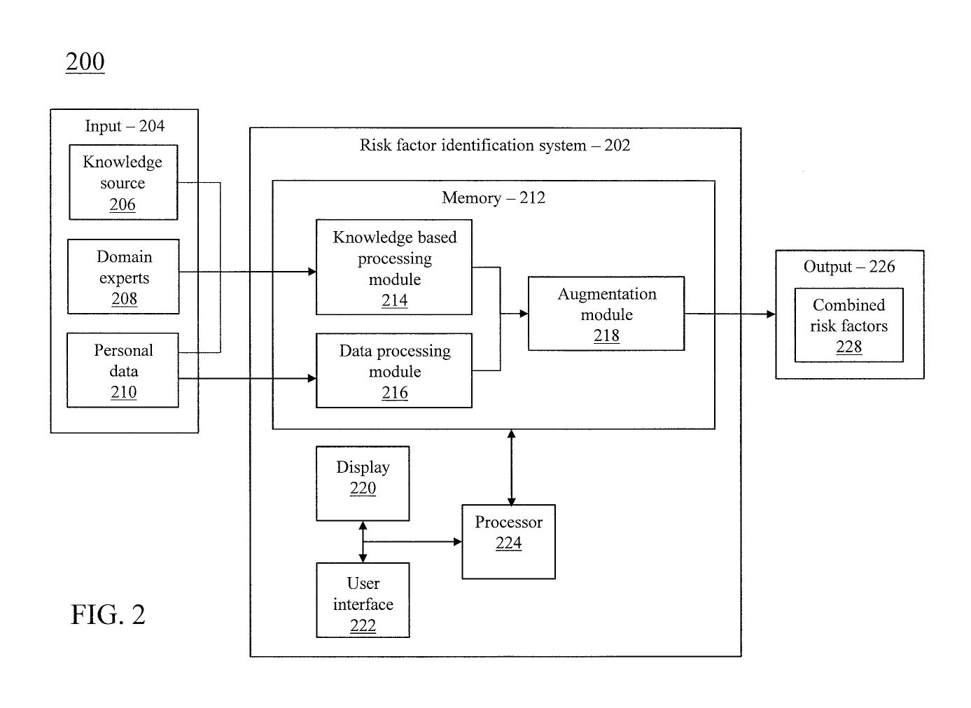

Referring now to FIG. 2, a block diagram showing a system for risk factor identification 200 is illustratively depicted in accordance with one embodiment. Risk factor identification system 202 preferably includes one or more processors 224 and memory 212 for storing programs and applications. It should be understood that the functions and components of system 200 may be integrated into one or more systems.

Risk factor identification system 202 may include one or more displays 220 for, e.g., viewing input or resulting risk factors. The display 220 may also permit a user to interact with system 202 and its components and functions. This is further facilitated by a user interface 222, which may include a keyboard, mouse, joystick, or any other peripheral or control to permit user interaction with system 202.

Risk factor identification system 202 may receive one or more inputs 204, which may include knowledge source 206, domain experts 208 and personal data 210. In one embodiment, input 204 may be stored in memory 212. Knowledge source 206 may include, but is not limited to, any veracious information source, such as, for example, credited clinical guidelines, medical literature, publications, etc. Domain experts 208 may include expert (e.g., physician) input of the identification of risk factors corresponding to a given disease condition. Personal data 210 may include the electronic health records of patients, including, for example, diagnosis information, medication information, lab results, diagnostic symptoms, vital information, etc. Input 204 may be facilitated by the use of display 220 and user interface 222.

In a preferred embodiment, the present principles are particularly useful for the identification of risk factors associated with adverse health conditions, such as congestive heart failure. However, it should be understood that the teachings of the present principles are much broader than this, as the present principles may be applied to any situation where multiple potential attributes could be predictive of a future event. For example, the present principles may be applicable to predict future events in financial investment analysis. In another example, the present principles may be applied to predict social behavior. Other applications are also contemplated within the scope of the present principles.

Memory 212 may include knowledge based processing module 214, data processing module 216 and augmentation module 218, each configured to perform various functions. It should be understood that the modules may be implemented in various combinations of hardware and software.

Knowledge based processing module 214 is configured to identify risk factors from knowledge source 206 and/or domain experts 208. Risk factor identification may include parsing knowledge source 206 to identify references to clinical concepts and disease conditions. In one embodiment, parsing of knowledge source 206 includes utilizing a medical thesaurus such as the Unified Medical Language System (UMLS). Other methods of parsing have also been contemplated. Risk factors are mapped to a disease condition based on co-occurrence patterns. Identifying risk factors from domain experts 208 includes receiving direct user input from, e.g., experts in the field. Users may identify disease conditions of interest and input corresponding risk factors.

Knowledge based processing module 214 is further configured to validate the identified risk factors using personal data 210, in accordance with one embodiment. Validating may include removing risk factors from further consideration that are found to be irrelevant based on statistical data. For example, in one embodiment, irrelevant risk factors may include risk factors with a small variance or low correlation. Other methods of validating risk factors are also contemplated. The remaining risk factors are mapped to the structured fields in personal data 210. Knowledge based gathering module 214 outputs knowledge driven risk factors to augmentation module 218.

Data processing module 216 is configured to identify data driven risk factors using feature selection techniques from personal data 210. For example, in one embodiment, risk factors that are highly correlated with the disease condition of interest may be selected by data processing module 216. Other feature selection techniques have also been contemplated. Patient profiles may be created including potential risk factors for various diseases. Labels are created for patients for the disease conditions of interest. Data processing module 216 outputs the data driven risk factors and the target conditions to augmentation module 218.

Augmentation module 218 is configured to select data driven risk factors (from data processing module 216) that augment the knowledge driven risk factors (from knowledge based processing module 214). In one embodiment, the augmentation module 218 is configured to model the number of data driven risk factors and the number of knowledge based risk factors as an objective function. Augmentation module 218 may be further configured to minimize the objective function using iterative methods to select data driven risk factors that augment the knowledge based risk factors.

In a particularly useful embodiment, augmentation module 218 applies the SOR model. The SOR model ensures that the data driven risk factors are highly predictive of the adverse condition of interest. The SOR model further ensures that there is little to no correlation between the data driven risk factors and the knowledge driven risk factors, so that the data driven risk factors do indeed contribute to new understanding of the condition and potentially lead to new treatment or management options. In addition, the SOR model ensures that there is little to no correlation among the data driven risk factors from the clinical data 210 to further ensure quality of the data driven risk factors.

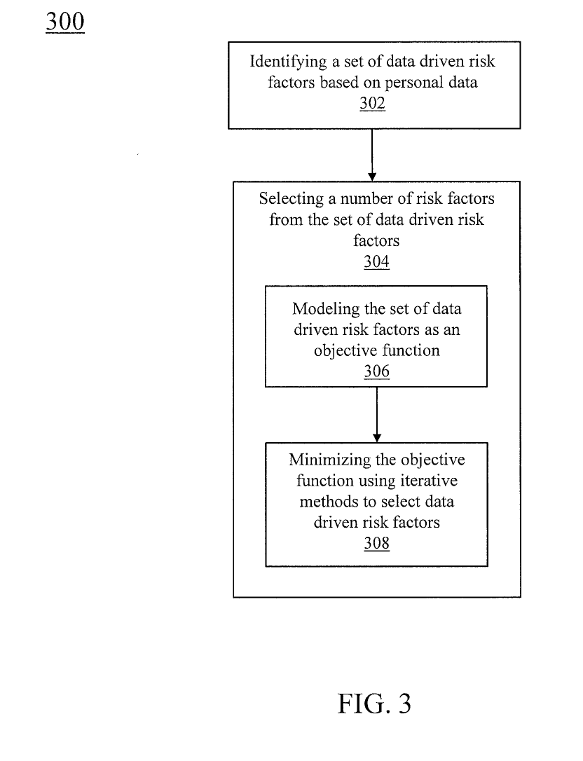

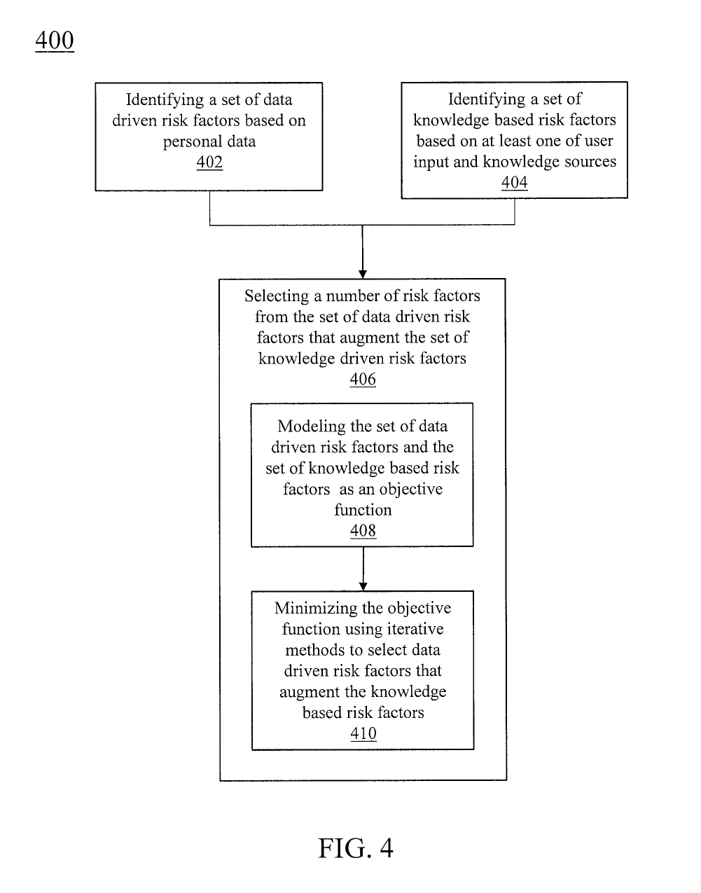

Augmentation module 218 produces output 226, which may include a list of combined risk factors 228. Output 226 may be facilitated by the use of display 220 and user interface 222. Details of the functions and operations of the risk factor identification system 202 will be described in more detail with respect to the methods for identifying risk factors in FIG. 3 and FIG. 4.

The SOR model provides several advantages: 1) Scalability: SOR achieves nearly linear scale-up with respect to the number of input features and the number of samples; 2) Optimality: SOR is formulated as an alternative convex optimization problem with theoretical convergence and global optimality guarantee; 3) Low-redundancy: SOR is designed specifically to select less redundant features without sacrificing quality; 4) Extendability: SOR can enhance preselected expert identified features by adding additional features derived from clinical data that complement the expert identified feature set but still with strong predictive power. Advantageously, the present principles are more reliable and interpretable than pure data driven approaches. In addition, the present principles are also more comprehensive and efficient than pure knowledge based approaches.

It is noted that the present principles may be applicable to identify risk factors as a data driven approach (i.e., using clinical data alone to derive risk factors) in accordance one embodiment. However, in a preferred embodiment, the present principles select data driven risk factors that are complementary to knowledge driven risk factors that are preselected from user input and/or knowledge sources. A data driven method for risk factor identification will first be discussed, in accordance with one embodiment.

Referring now to FIG. 3, a flow diagram showing a method for a data driven approach to risk factor identification 300 is illustratively depicted in accordance with one embodiment. In block 302, a set of data driven risk factors are identified based on personal data. Personal data may include, for example, electronic health records such as diagnosis information, medication information, lab results, vital information, etc. Risk factors are identified from the personal data using feature selection techniques. For example, in one embodiment, risk factors that are highly correlated with the disease condition of interest may be selected. Other feature selection techniques have also been contemplated. The feature selection techniques are supervised, such that a user labels disease conditions of interests. Feature vectors may include variables as potential risk factors for various disease conditions. Potential risk factors may include statistic measures derived from clinical events in the personal data. Each distinct clinical event is considered a risk factor. In one embodiment, for discrete events such as diagnosis and medication information, the number of occurrences may be used as risk factors. In yet another embodiment, for continuous events such as blood pressure and laboratory results, the average of the measures may be computed as risk factors. In one embodiment, invalid and noisy outliers may be removed prior to computing the average of the measures.

The number of risk factors may be represented as matrix. Data matrix X is used to denote the data matrix containing n observations on the p risk factors from the personal data, such that X=[x₁, x₂, . . . , xₚ]ε [symbol] ^{n×p}. Without the loss of generality, it is assumed that all feature vectors are normalized, i.e., ∥xᵢ∥₂=1 (i=1, . . . , p). Since feature selection is supervised, the corresponding response vector yε [symbol] ⁿ is provided.

In block 304, a number of risk factors are selected from the set of data driven risk factors. This may include, in block 306, modeling the set of data driven risk factors as an objective function. The objective function may be represented as a linear regression problem under square loss, which may take the following form in equation (1):

$${min}_{α} {J}_{r} ( α ) , {J}_{r} ( α ) = \frac{1}{2} {‖ y - X α ‖}^{2} = \frac{1}{2} {‖ y - {\sum }_{j} {α}_{j} {x}_{j} ‖}^{2} , \qquad ( 1 )$$

where α=[α₁, α₂, . . . , αₚ]^{T}ε [symbol] ⁿ is the regression coefficient vector. Regression coefficients may represent the slope of the objective function. The absolute value of |αⱼ| can be regarded as the importance of risk factor j, where j=1, 2, . . . , p. The risk factor i is found to be irrelevant where αᵢ=0, and is therefore not selected. Conversely, risk factor i is selected where αᵢ≠0.

In a particularly useful embodiment, a number of risk factors are modeled as an objective function such that the selected risk factors are non-redundant. Given two risk factors xᵢ and xⱼ, as well as their corresponding regression coefficients αᵢ and αⱼ (which are fixed) as in Equation (1), redundancy between them may be provided as in equation (2):

Rᵢⱼ=(αᵢαⱼxᵢ^{T}xⱼ^{T})². (2)

If xᵢ and xⱼ are orthogonal to each other, then xᵢ^{T}xⱼ=0 and Rᵢⱼ=0, indicating that they are non-redundant. If xᵢ and xⱼ are identical, then xᵢ^{T}xⱼ is maximized.

In order to obtain a set of non-redundant risk factors, equation (1) representing linear error is modified to account for redundancy as in equation (2). As such, the following objective in equation (3) may be minimized:

$${J}_{o} ( α ) = \frac{1}{2} {‖ y - X α ‖}^{2} + \frac{β}{4} {\sum }_{ij} {( {α}_{i} {x}_{i}^{T} {x}_{j} {α}_{j} )}^{2} , \qquad ( 3 )$$

where the term

$$\frac{1}{2} {‖ y - X α ‖}^{2}$$

represents regression error, the term ΣᵢⱼRᵢⱼ=Σᵢⱼ(αᵢxᵢ^{T}xⱼαⱼ)² represents the summation of the redundancies over all of the risk factors, and β is a tradeoff parameter which controls the importance of the redundancy.

In yet another embodiment, the number of selected risk factors is as small as possible. Thus, a sparsity penalty term of ∥α∥₁ is imposed on the objective function of equation (3). The goal then becomes to minimize the following objective in equation (4):

$$J ( α ) = \frac{1}{2} {‖ y - X α ‖}^{2} + λ {‖ α ‖}_{1} + \frac{β}{4} {\sum }_{ij} {( {α}_{i} {x}_{i}^{T} {x}_{j} {α}_{j} )}^{2} , \qquad ( 4 )$$

where ∥α∥₁ is the l₁ norm of α:∥α∥₁=Σⱼ|aⱼ| and λ is a model parameter which controls the sparsity. It can be shown that if λᵢ≧maxᵢ|(X^{T}y)ᵢ|, then the optimal solution of equation (4) is α=0. Thus, the parameter λ has a natural range from 0 to λₘₐₓ=maxᵢ|(X^{T}y)ᵢ|. As noted above, the risk factor i is not selected where αᵢ=0, while the risk factor i is selected where αᵢ≠0. Without the loss of generalization, a normalized λ (ranging from 0 to 1, where λ=1 indicates the use of λₘₐₓ) will be used. Once the optimal solution of α* is obtained, the absolute values of |αᵢ*| is used to represent the importance of features.

In block 308, the objective function may be minimized using iterative methods to select data driven risk factors. The objective function of equation (4) is minimized to select non-redundant risk factors by applying the SOR method. Initially, preliminaries on how to minimize equation (4) using the SOR method will be discussed. For notational convenience, ƒ(α) will be used to represent Jₒ(α), as in equation (5):

$$f ( α ) = {J}_{o} ( α ) = \frac{1}{2} {‖ y - X α ‖}^{2} + \frac{β}{4} {\sum }_{ij} {( {α}_{i} {x}_{i}^{T} {x}_{j} {α}_{j} )}^{2} . \qquad ( 5 )$$

The objective ƒ(α) of equation (5) can be said to be locally Lipschitz continuous. A function ƒ: [symbol] _{d}→ [symbol] ^{m} is Lipschitz continuous if for ∀a, bεR^{d}, a constant L can be found satisfying the following inequality: ∥a−b∥≦L∥ƒ(a)−ƒ(b)∥. The function ƒ is called locally Lipschitz continuous if, for each cεR^{m} there exists an L>0 such that ƒ is Lipschitz continuous on the open ball of center c and radius L.

As ƒ(α) is continuously smooth, the gradient of ƒ(α) is locally Lipschitz continuous, resulting in the following inequality of equation (6):

$$f ( \tilde{α} ) \leq f ( \tilde{α} ) + {( α - \tilde{α} )}^{T} ∇ f ( \tilde{α} ) + \frac{L}{2} {‖ α - \tilde{α} ‖}^{2} , \qquad ( 6 )$$

which leads to equation (7):

$$f ( α ) + λ {‖ α ‖}_{1} \leq f ( \tilde{α} ) + {( α - \tilde{α} )}^{T} ∇ f ( \tilde{α} ) + \frac{L}{2} {‖ α - \tilde{α} ‖}^{2} + λ {‖ α ‖}_{1} . \qquad ( 7 )$$

The right hand side of equation (7) is denoted by Z(α,\tilde{α}), represented in equation (8) as follows:

$$Z ( α , \tilde{α} ) = f ( \tilde{α} ) + {( α - \tilde{α} )}^{T} ∇ f ( \tilde{α} ) + \frac{L}{2} {‖ α - \tilde{α} ‖}^{2} + λ {‖ α ‖}_{1} , \qquad ( 8 )$$

where ∇ƒ is the gradient of ƒ. Equation (8) will be used to derive an efficient iterative method which is guaranteed to converge at the global minimum of equation (4). Bringing J(α) from equation (4) into equation (8), it can be found that J(α)=Z(α,α)≦Z(α,\tilde{α}). Then letting \tilde{α}=α^{t} and

$${α}^{t + 1} = arg {min}_{α} Z ( α , {α}^{t} ) \qquad ( 9 )$$

results in equation (10) as follows:

J(α^{t+1})=Z(α^{t+1},α^{t+1})≦Z(α^{t+1},α^{t})≦Z(α^{t},α^{t})=J(α^{t}). (10)

From equation (10), it can be seen that α can be iteratively updated by solving equation (9) (i.e., minimizing Z(α,\tilde{α}) with \tilde{α}=α^{t}) to decrease the objective function monotonically.

Based on the above preliminaries, in order to minimize equation (4), the following sub-problem in equation (11) is iteratively solved:

$${min}_{α} Z ( α , {α}^{t} ) . \qquad ( 11 )$$

As ƒ(α^{t}) is constant with respect to α, the following objective in equation (12) can be minimized instead with respect to α:

$${J}_{m} ( α ) = {( α - {α}^{t} )}^{T} ∇ f ( {α}^{t} ) + \frac{L}{2} {‖ α - {a}^{t} ‖}^{2} + λ {‖ α ‖}_{1} , \qquad ( 12 )$$

where the gradient of ƒ(α) is as follows in equation (13):

[∇ƒ(α)]ᵢ=└X^{T}Xα┘ᵢ+βΣⱼ(αᵢαⱼxᵢ^{T}xⱼ)xᵢ^{T}xⱼαⱼ. (13)

The gradient of ƒ(α) in equation (13) can be written in its matrix form as follows in equation (14):

∇ƒ(α)=(G+βA⊙G⊙G)α−X^{T}y, (14)

where A=αα^{T}, G=X^{T}X, and ⊙ is the matrix Hadamard (elementwise) product.

The minimization of equation (12) will be shown to have closed form solutions. First, as ∥∇ƒ(α^{t})∥ is a constant with respect to α, then minimizing Jₘ(α) in equation (12) is equivalent to minimizing the following:

$${J}_{m} ( α ) + \frac{1}{2 {L}^{2}} {‖ ∇ f ( {α}^{t} ) ‖}^{2} = {( α - {α}^{t} )}^{T} ∇ f ( {α}^{t} ) + \frac{L}{2} {‖ α - {α}^{t} ‖}^{2} + \frac{1}{2 {L}^{2}} {‖ ∇ f ( {α}^{t} ) ‖}^{2} + λ {‖ α ‖}_{1} = \frac{L}{2} {‖ α - ( {α}^{t} - \frac{1}{L} ∇ f ( {α}^{t} ) ) ‖}^{2} + λ {‖ α ‖}_{1} . \qquad ( 15 )$$

The closed form solution for minimizing equation (12) can be found by applying Lemma 1 as follows.

Lemma 1.

The global minimum solution of minimizing the following objective of equation (16) over u

$$J ( u ) = \frac{1}{2} {‖ u - a ‖}^{2} + μ {‖ u ‖}_{1} , \qquad ( 16 )$$

where u=[u₁, u₂, . . . , uₚ]^{T} and a=[a₁, a₂, . . . , aₚ]^{T} are p×1 vectors, is given by

$${u}_{i} = \{ \begin{matrix}0 & if μ \geq \vert {a}_{i} \vert \\ \frac{\vert {a}_{i} \vert - μ}{\vert {a}_{i} \vert} {a}_{i} & if μ < \vert {a}_{i} \vert\end{matrix} , i + 1 , 2 , … p ,$$

or equivalently,

uᵢ=(|aᵢ|−μ)₊sign(aᵢ), (17)

where (x)₊=x if x>0, (x)₊=0 if x<=0 and sign (•) is the sign function (sign (0) is provided as 0 here).

By applying Lemma 1 and letting μ=λ/L, u=α,

$$a = {α}^{t} - \frac{1}{L} ∇ f ( {α}^{t} ) ,$$

the following closed form optimal solution for minimizing equation (12) can be found:

$${α}^{i} = {( \vert {[ {α}^{t} - \frac{1}{L} ∇ f ( {α}^{t} ) ]}_{i} \vert - \frac{λ}{L} )}_{+} sign ( {[ {α}^{t} - \frac{1}{L} ∇ f ( {α}^{t} ) ]}_{i} ) , \qquad ( 18 )$$

where i=1, 2, . . . , p.

The steps of the SOR method for iteratively minimizing equation (4) are generally summarized in Pseudocode 1 as follows, in accordance with one embodiment of the present principles. In the SOR method, γ is an optimization parameter to increase L when the Lipschitz condition is not satisfied. In one embodiment, optimization parameter γ may be set to be a value of 1.2.

Psuedocode 1: Scalable Orthogonal Regression method

```
input: λ, L₀, a₀, γ
initialize α = α₀, L = L₀
while No Convergence do
  compute ∇f(α) using equation (14)
  set aᵢ to aᵢ = αᵢ − [∇f(α)]ᵢ/L
  $solve {\tilde{α}}_{i} by {\tilde{α}}_{i} = {( \vert {a}_{i} \vert - \frac{λ}{L} )}_{+} sign ( {a}_{i} ) ( equation ( 18 ) )$
  if J(\tilde{α}) < J(α) then
    set α ← \tilde{α}
  else
    set L ← γL
  end if
end while
output α
```

As noted above, the objective of equation (4) is convex with respect to α. In addition, ƒ in equation (5) is locally Lipschitz continuous. There also exists a global L such that equation (5) is Lipschitz continuous at αₜ with Lipschitz continuity constant L, where αₜ is the result of the SOR method at the t-th iteration. Since the value of J(α) is monotonically decreased by the SOR method and is lower bounded by zero, the SOR method will converge. Based on the convexity and Lipschitz continuity of the SOR method, the convergence rate can be determined.

The convergence rate of the SOR method may be provided by equation (19) as follows:

$$J ( {α}_{T} ) - J ( {α}^{*} ) \leq \frac{{L}_{T} {‖ {α}_{0} - {α}^{*} ‖}^{2}}{2 T} , \qquad ( 19 )$$

where T is the number of iterations in the SOR method, L_{T} is the value of L at the last iteration, α* is the global optimal regression coefficient of equation (4), and α_{T} is the output of the SOR method. Convergence of the SOR method to the global solution is guaranteed since J(α_{T})−J(α*)→0 as T→∞. Note that L_{T}≦L because of the locally Lipschitz continuity of ƒ(α).

The computational complexity of the SOR method will now be discussed. Specifically, solving for α in Psuedocode 1 takes O(p) time, where p is the dimension of α. The computational bottleneck in Pseudocode 1 is the evaluation of the gradient of ƒ(α) in equation (14), which takes O(np²) time during the first iteration. However, a more efficient method of obtaining the gradient in O(np) time is developed. First, B=X⊙(αe^{T}) is first computed, where e=[1, 1, . . . 1]^{T} with proper size. Then, Bₗⱼ=αⱼxⱼ^{l}, where xⱼ^{l} is the l-th element of xⱼ or bⱼ=αⱼxⱼ, where bⱼ is the j-th column of B. The computation of B takes O(np) time. Then the term Σⱼ(αᵢαⱼxᵢ^{T}xⱼ)xᵢ^{T}xⱼαⱼ=αᵢ(xᵢ^{T}Σⱼbⱼ)² takes O(np) time, which does not depend on the index i. Note that computing xᵢ^{T} v only takes O(n) time, while X^{T}Xy=X^{T}(Xy) takes O(np) time. Thus, the whole complexity of computing the gradient is O(np).

Referring now to FIG. 4, a flow diagram showing a method for risk factor identification by augmenting knowledge based risk factors with data driven risk factors 400 is illustratively depicted, in accordance with a preferred embodiment of the present principles. In many real world scenarios, experts may have a preselected set of risk factors. For example, physicians in hospitals may have years of experience working with specific diseases such that they have their own knowledge of which risk factors are more important. In accordance one embodiment, data driven risk factors are derived from personal information that are complementary to the knowledge driven (e.g., expert preselected) risk factors.

The method for a data driven approach to risk factor identification 300 can be adapted to incorporate knowledge based risk factors. As in the data driven approach, in block 402, a set of data driven risk factors are identified based on personal data. However, in addition, in block 404, a set of knowledge based risk factors are identified based on at least one of user (e.g., expert) input and knowledge sources. Knowledge sources may include, for example, veracious sources of information such as publications, medical literature, results of clinical trials, etc. Knowledge sources are parsed to identify risk factors as references to clinical concepts and disease conditions. In one embodiment, parsing of knowledge sources includes utilizing a medical thesaurus such as the UMLS. Other methods of parsing have also been contemplated. Risk factors may be mapped to disease conditions of interest identified by users based on their co-occurrence patterns.

In one embodiment, the identified risk factors may be validated using the personal data database. Risk factors are removed from further consideration based on statistical data, such as, e.g., small variance, low correlation to target condition, etc. Other methods of validating risk factors are also contemplated. The remaining risk factors are mapped to the structured fields in personal data database.

It is assumed that the knowledge driven risk factor set is [symbol] and the data driven risk factor set is [symbol] . The data matrix X can be partitioned as X= [symbol] [symbol] , where [symbol] and [symbol] only contain the observations on the risk factors in [symbol] and [symbol] , respectively. The goal is to select risk factors from [symbol] that are complimentary to the risk factors in [symbol] .

In block 406, a number of risk factors are selected from the set of data driven risk factors that augment the set of knowledge driven risk factors. Block 406 may include, in block 408, modeling the set of data driven risk factors and the set of knowledge based risk factors as an objective function. For risk factor set [symbol] , regression coefficients are computed with simple least squares, as in equation (21) as follows:

$${α}_{𝒫} = arg {min}_{α} {‖ y - {X}_{𝒫} α ‖}^{2} = {( {X}_{𝒫}^{T} {X}_{𝒫} )}^{- 1} {X}_{𝒫}^{T} y . \qquad ( 21 )$$

The regression model of equation (21) represents a reconstruction error to capture how accurate the combined set of risk factors can estimate the disease condition of interest. Then, the following objective function is determined in equation (22):

$${f}_{p} ( α ) = \frac{1}{2} {‖ y - {X}_{𝒬} α ‖}^{2} + \frac{β}{4} [ {\sum }_{ij ∈ 𝒬} {( {α}_{i} {x}_{i}^{T} {x}_{j} {α}_{j} )}^{2} + {\sum }_{i ∈ 𝒬 , j = 𝒫} {( {α}_{i} {x}_{i}^{T} {x}_{j} {α}_{j} )}^{2} ] , \qquad ( 22 )$$

where α [symbol] is the concatenated regression coefficient vector with [symbol] computed using equation (21).

Note that there are two terms to punish the feature redundancy. The term

$$\frac{β}{4} [ {\sum }_{ij ∈ 𝒬} {( {α}_{i} {x}_{i}^{T} {x}_{j} {α}_{j} )}^{2} ]$$

measures risk factor redundancy selected from [symbol] , the data driven risk factors. The term

$$\frac{β}{4} [ {\sum }_{i ∈ 𝒬 , j ∈ 𝒫} {( {α}_{i} {x}_{i}^{T} {x}_{j} {α}_{j} )}^{2} ]$$

measures risk factor redundancy between risk factors selected from [symbol] , the data driven risk factors, and [symbol] , the knowledge driven risk factors. A sparsity penalty λ∥α∥₁ is added to enforce that a small number of data driven risk factors from [symbol] are selected. The goal is to minimize the following objective function of equation (23) with respect to [symbol] :

$${J}_{p} ( α ) = \frac{1}{2} {‖ y - {X}_{𝒬} α ‖}^{2} + \frac{β}{4} [ {\sum }_{ij ∈ 𝒬} {( {α}_{i} {x}_{i}^{T} {x}_{j} {α}_{j} )}^{2} + \frac{β}{4} {\sum }_{i ∈ 𝒬 , j ∈ 𝒫} {( {α}_{i} {x}_{i}^{T} {x}_{j} {α}_{j} )}^{2} ] + λ {‖ α ‖}_{1} . \qquad ( 23 )$$

In block 410, the objective function is minimized using iterative methods to select data driven risk factors that augment the knowledge based risk factors. Comparing the objective of equation (4), pertaining to a data driven approach to risk factor identification, with the objective of equation (23), pertaining to combining a data driven approach with a knowledge based approach for risk factor identification, it can be seen that the SOR method is still applicable for minimizing equation (23). The only step that changes is the computation of the gradient. Note that in optimization for the combined approach to risk factor identification, αⱼ is constant for jε [symbol] . The corresponding gradient is as follows in equation (24):

∇ƒₚ(α)=(G+βA [symbol] [symbol] )α−X^{T}y+ [symbol] ⊙α. (24)

Having described preferred embodiments of a system and method for combining knowledge and data driven insights for identifying risk factors in healthcare (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A system for risk factor identification, comprising:
a data processing module configured to identify a first set of risk factors from personal data;
a knowledge based processing module configured to identify a second set of risk factors from at least one of a user input and a knowledge source; and
a processor configured to implement an augmentation module, the augmentation module configured to combine the first set with the second set by selecting a number of risk factors from the first set that augment the second set of risk factors to determine a combined list of risk factors that predict a condition of interest.

2. The system as recited in claim 1, wherein the augmentation module is further configured to model the first set and the second set as an objective function.

3. The system as recited in claim 2, wherein the objective function includes a regression model as a reconstruction error representing how accurate the combined list of risk factors predicts the condition of interest.

4. The system as recited in claim 2, wherein the objective function includes:
a measure of redundancy among the first set of risk factors; and
a measure of redundancy between the first set and the second set of risk factors.

5. The system as recited in claim 2, wherein the objective function includes a sparsity term to limit the number of selected risk factors from the first set.

6. The system as recited in claim 2, wherein the augmentation module is further configured to minimize the objective function using iterative methods.

7. The system as recited in claim 6, wherein the augmentation module is further configured to minimize the objective function with respect to a set of regression coefficients.

8. The system as recited in claim 6, wherein the augmentation module is further configured to iteratively update a regression coefficient until the regression coefficient converges to a global solution.

9. The system as recited in claim 2, wherein the objective function is
$$\frac{1}{2} {‖ y - {X}_{𝒬} α ‖}^{2} + \frac{β}{4} [ {\sum }_{ij ∈ 𝒬} {( {α}_{i} {x}_{i}^{T} {x}_{j} {α}_{j} )}^{2} + \frac{β}{4} {\sum }_{i ∈ 𝒬 , j ∈ 𝒫} {( {α}_{i} {x}_{i}^{T} {x}_{j} {α}_{j} )}^{2} ] + λ {‖ α ‖}_{1} ,$$
and further wherein [symbol] is a set of data driven risk factors, [symbol] is a set of knowledge based risk factors, X is a matrix including [symbol] and [symbol] , [symbol] is a matrix of [symbol] , α is a regression coefficient vector, β is a tradeoff parameter, ∥α∥₁ is the l₁ norm of α, λ is a model parameter, and y is a response vector.

10. The system as recited in claim 2, wherein the augmentation module is further configured to construct feature vectors for the risk factors of the first set and the risk factors of the second set, and further wherein the feature vectors include statistic measures for the risk factors of the first set and the risk factors of the second set.

11. A system for risk factor identification, comprising:
a data processing module configured to identify a first set of risk factors from personal data;
a knowledge based processing module configured to identify a second set of risk factors from at least one of a user input and a knowledge source; and
a processor configured to implement an augmentation module, the augmentation module configured to combine the first set with the second set by selecting a number of risk factors from the first set that augment the second set of risk factors,
the augmentation module further configured to model the first set and the second set as an objective function and minimize the objective function with respect to a set of regression coefficients to determine a combined list of risk factors that predict a condition of interest.

12. The system as recited in claim 11, wherein the objective function includes a regression model as a reconstruction error representing how accurate the combined list of risk factors predicts the condition of interest, a measure of redundancy among the first set of risk factors, a measure of redundancy between the first set and the second set of risk factors, and a sparsity term to limit the number of selected risk factors from the first set.

13. A computer readable storage medium comprising a computer readable program for risk factor identification, wherein the computer readable program when executed on a computer causes the computer to perform the steps of:
identifying a first set of risk factors from personal data;
identifying a second set of risk factors from at least one of a user input and a knowledge source; and
combining, using a processor, the first set with the second set by selecting a number of risk factors from the first set that augment the second set of risk factors to determine a combined list of risk factors that predict a condition of interest.
